(19) United States
(12) Patent Application Publication
(10) Pub. No.: US 2017/0258055 A1
(43) Pub. Date: Sep. 14, 2017

(54) AQUARIUM LID AND AQUARIUM USING THE SAME

(71) Applicant: Northern Sky Ventures Limited, Hong Kong (HK)

(72) Inventor: Michael Brown, Ottawa (CA)

(21) Appl. No.: 15/456,617

(22) Filed: Mar. 13, 2017

(30) Foreign Application Priority Data
Mar. 11, 2016 (CN) 201620190808.5

(51) Int. Cl. A01K 63/00

(52) U.S. Cl. CPC A01K 63/003

(57) ABSTRACT

Disclosed is an aquarium lid. The aquarium lid comprises a lid body made of a transparent rigid material, wherein the shape of an outer edge of the aquarium lid is designed to have a shape adapted to the edge shape of a mouth of an aquarium, and the lid body is further provided with a plurality of shaped bumps, planar regions, through-holes, and edge notches; at least one shaped platform is formed at a top surface of the shaped bumps and/or between at least two shaped bumps. This disclosure also provides an aquarium having the aquarium lid with shaped bumps. The provided aquarium lid with shaped bumps, planar regions, through-holes, and edge notches and the aquarium having the same are simply structured and exhibit aesthetics that meets different demands of viewers.

### CROSS REFERENCE TO RELATED APPLICATIONS

The present application claims the benefit of Chinese Utility Model Application No. 201620190808.5 filed on Mar. 11, 2016. All the above are hereby incorporated by reference.

### TECHNICAL FIELD

The present invention relates to an aquarium lid and an aquarium using the same.

### BACKGROUND OF THE INVENTION

Generally, aquariums do not have lids for ensuring the water circulation or air circulation. Even if there is a lid, it is for the purpose of dust prevention or in consideration of keeping the water within the aquarium clean and ensuring the security when observing the animals and plants. Accordingly, there are two most common aquarium lids, one of which is a simple separable lid and the other is an inseparable lid integrally formed on an aquarium. These two types of lids are merely capable of preventing dust or extraneous matter from entering the aquarium or carrying accessory devices of an aquarium such as electric wires, air hoses and etc. The former is dull in structure while the latter is too complicated, both of which lower the viewing effect of the aquarium and fail to meet the different demands of viewers.

### SUMMARY OF THE INVENTION

In order to overcome the disadvantages of the prior art, the present invention provides an aquarium lid and an aquarium using the same.

The invention provides an aquarium lid. The technical solution thereof is as follows.

An aquarium lid, comprising a lid body made of a transparent rigid material, an outer edge of the aquarium lid being designed to have a shape adapted to an edge of a mouth of an aquarium, the lid body being further provided with one or more shaped bumps, planar regions, through-holes, and edge notches; wherein the planar region is formed at a top surface of the shaped bumps and/or between at least two shaped bumps.

Preferably, the aquarium lid further comprises an accessory frame, wherein the accessory frame is arranged on an edge of an side wall of the mouth of the aquarium and provided with a horizontally extended edge directing toward the interior of the aquarium; the outer edge of the lid body is attached onto an upper surface of the horizontally extended edge.

Further, the horizontally extended edge of the accessory frame is located under a topmost part of the side wall of the mouth of the aquarium.

Preferably, the lid body is made of materials including, but not limited to, translucent or transparent glass or plastic.

Preferably, the shaped bump is peak-shaped.

Preferably, one side of the lid body is provided with an edge notch.

Preferably, the shaped bumps and/or the planar region between at least two shaped bumps has one or more through-holes.

Preferably, the through-holes comprises different shapes.

The present invention also provides an aquarium, which comprises any one of the aquarium lids with shaped bumps described above.

Further, the aquarium optionally comprises a lighting system located under the aquarium.

Furthermore, the lighting system comprises a plurality of LED lights emitting different colors.

The beneficial effects of the present invention are as follows. The present invention provides an aquarium lid with shaped bumps and an aquarium using the same, both of which are simple in structure and aesthetic in shape design, thereby satisfying different demands of viewers. The edge notches of the lid body provide clearance for typical aquarium maintenance equipment such as filters, heaters, etc. The planar regions of the lid body are suitable for placement of figurines and assorted decorative objects. The through-holes are suitable for installation of decorative objects that will break the water surface below.

### BRIEF DESCRIPTION OF THE DRAWINGS

FIG. 1 is a side view of an aquarium lid according to an embodiment of the present invention.

FIG. 2 is a schematic view of an aquarium lid according to an embodiment of the present invention.

FIG. 3 is a side view of an aquarium covered with an aquarium lid according to another embodiment of the present invention.

FIG. 4 is a top view of an aquarium lid with shaped bumps shown as elevation contours, an edge notch and through-holes of different shapes.

FIG. 5 is a side view of an aquarium covered with an aquarium lid in which a hanging and downwards pointing decorative object is to be installed into a through-hole.

FIG. 6 is a side view of an aquarium covered with an aquarium lid in which a hanging and downwards pointing decorative object has been installed into the lid through-holes and said object is breaking the water surface.

FIG. 7 is a side view of an aquarium covered with an aquarium lid onto which a plurality of decorative objects may be placed on the planar regions of the aquarium lid.

FIG. 8 is a side view of an aquarium covered with an aquarium lid onto which a plurality of decorative objects have been placed, and into which a hanging and downwards pointing decorative object has been loaded.

### DETAILED DESCRIPTION OF THE INVENTION

Hereinafter, the embodiments of the present invention will be described clearly and completely with reference to the accompanying drawings. Obviously, those exemplary embodiments are only a part of the embodiments of the invention. Any other embodiments made by those skilled in the art in light of teachings of the present invention should be deemed as falling within the scope of the present invention.

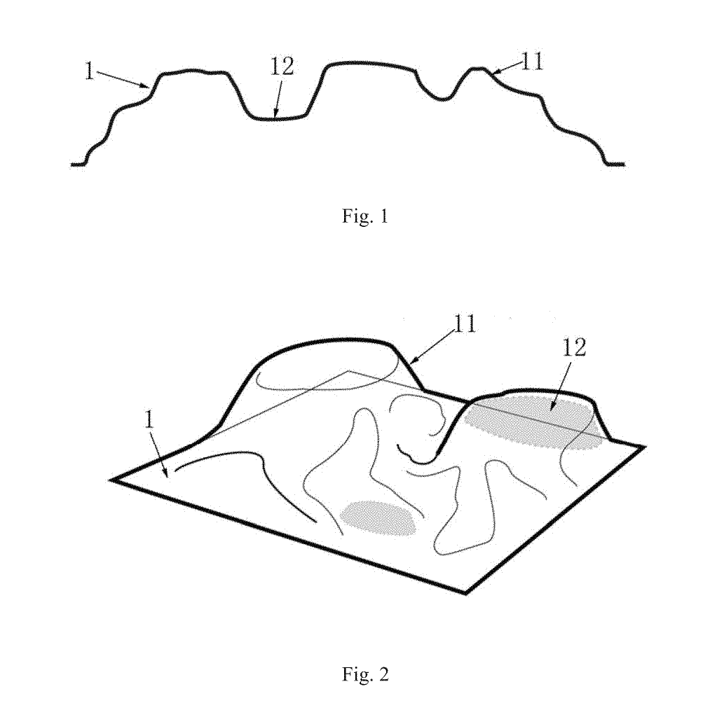

Referring to FIGS. 1 and 2, this invention provides an aquarium lid, comprising a lid body 1, wherein the lid body 1 is made of a transparent rigid material, an outer edge of the lid body 1 is designed to have a shape adapted to an edge of a mouth of an aquarium, the aquarium lid body 1 comprises a plurality of shaped bumps 11. As shown in FIG. 1, a planar region 12 is formed between two shaped bumps 11. However, as shown in FIG. 2, the planar region 12 may be formed at a top surface of the shaped bump 11. In another embodiment, it is conceivable that more than one planar regions may be formed at the top of the shaped bump and between the shaped bumps at the same time.

The lid body 1 is supported at a side wall of the mouth of the aquarium, pot cultures, pebbles, flowers, grass and other ornaments may be placed on the planar region 12 which is formed at the top surface of the shaped bumps 11 and/or between at least two shaped bumps 11. By doing so, the aquarium can be viewed in a beneficial way.

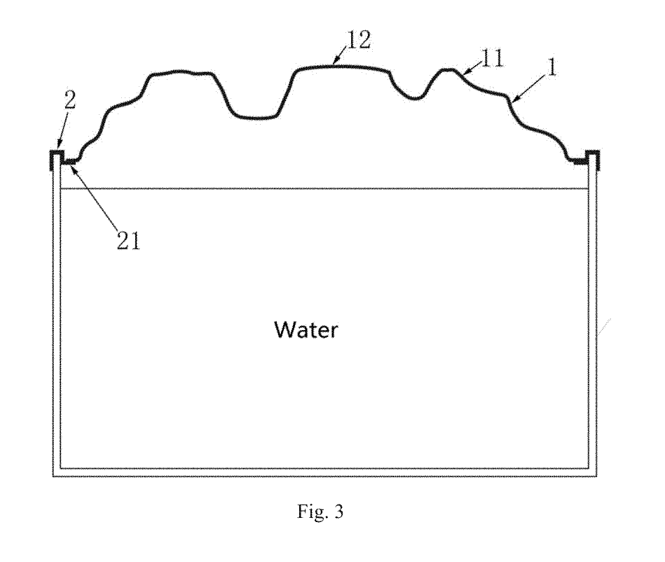

Referring to FIG. 3, in some embodiments of the present invention, the aquarium lid further comprises an accessory frame 2, wherein the accessory frame 2 is arranged on an edge of the side wall of the mouth of the aquarium and is provided with a horizontally extended edge 21 directing toward the interior of the aquarium; the outer edge of the lid body 1 is attached onto an upper surface of the horizontally extended edge 21. The horizontally extended edge 21 of the accessory frame 2 may be located under the topmost part of the side wall of the mouth of the aquarium, thereby preventing the lid body 1 from sideslip under an external force and thus increasing the security.

The lid body 1 is made of a transparent rigid material comprising, but not limited to, a translucent or transparent glass or plastic or the like. The shaped bump 11 is shaped as a peak. In a side view, the plurality of shaped bumps 11 look like a plurality of rolling icebergs presenting a better aesthetic beauty to satisfy different demands of viewers.

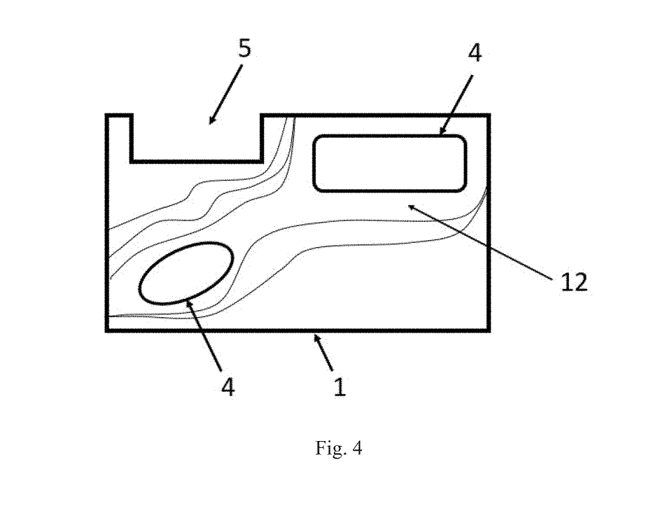

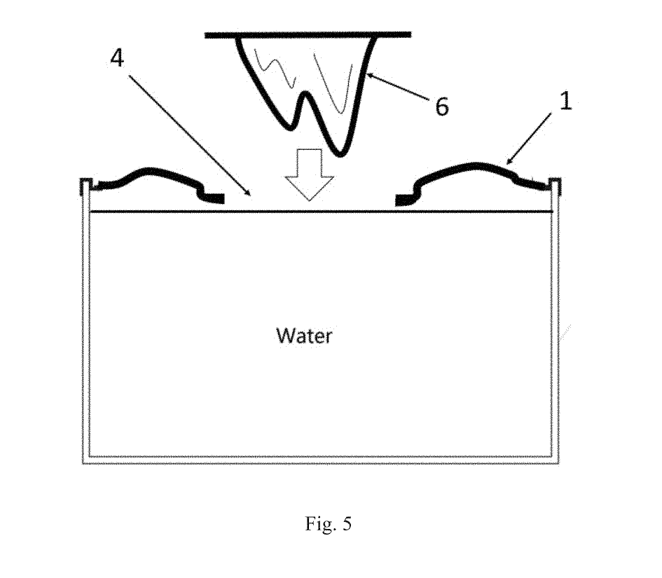

Referring to FIG. 4, in some embodiments of the present invention, one side of the lid body 1 is provided with an edge notch 5. The edge notch makes the water circulation and air circulation possible and further provides an access to the aquarium for feeding the ornamental fishes therein.

Referring to FIG. 4, in some embodiments of the present invention, the lid body 1 further comprises a through-hole 4 of different shapes suitable for installation of a hanging and downwards pointing decorative object 6.

Referring to FIG. 4, in some embodiments of the present invention, the lid body 1 comprises a planar region 12 suitable for placement of a decorative object.

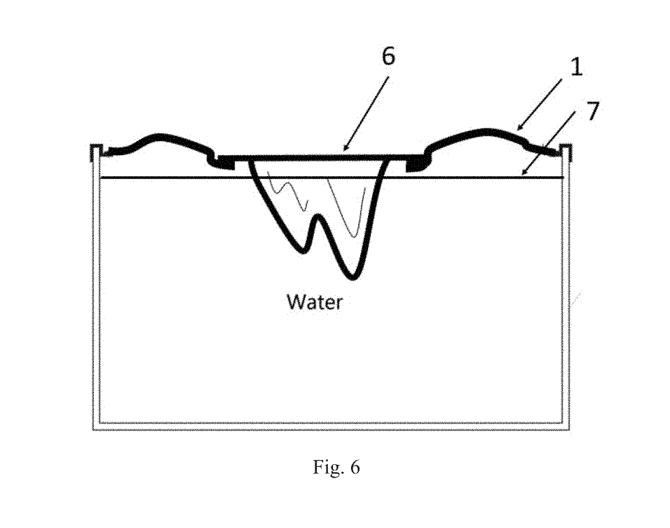

Referring to FIG. 5 and FIG. 6, in some embodiments of the present invention, the lid body 1 comprises a through-hole 4 suitable for loading a hanging and downwards pointing decorative object 6 that will break the water's surface 7.

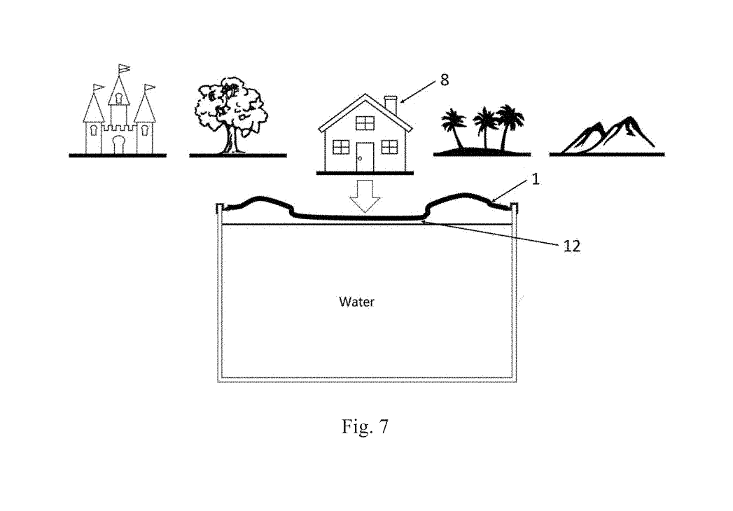

Referring to FIG. 7, in some embodiments of the present invention, the lid body 1 comprises a planar region 12 may be configured to accommodate a plurality of decorative objects 8 with real or imagined shape.

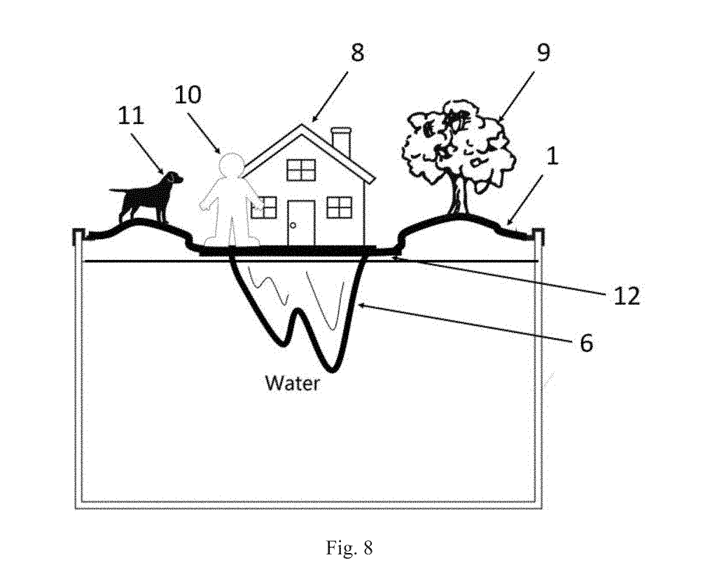

Referring to FIG. 8, in some embodiments of the present invention, the lid body 1 comprises a planar feature 12 which may be configured to accommodate a plurality of decorative objects 8 that are real or imagined. The through-holes of the lid body may be suitable for loading a hanging and downwards pointing object 6, and further decorative effect may be had with the addition of miniature figurines 10, 11, and natural elements 9. All such elements may be real or imaginary and optionally selected to represent a theme.

In another embodiment of the present invention, the shaped bumps 11 of the lid body 1 and/or the planar region between at least two shaped bumps 12 have a through-hole enabling the water circulation and air circulation and providing an access to the aquarium for feeding the ornamental fishes therein.

The present invention also provides an aquarium, the aquarium comprises any one of the above-mentioned aquarium lids having shaped bumps, planar regions, through-holes, and/or edge notches.

The aquarium, optionally comprises a lighting system located under the aquarium. The lighting system under the aquarium emits light upwardly, making the plurality of shaped bumps of the lid body 1 look like icebergs. The visual effect would be even better if the lighting system includes a plurality of LED lights emitting different colors.

While exemplary embodiments of the invention have been described above, it is to be realized that many modifications and variations thereto may be made by those skilled in the art without departing from the principle and spirit of the present invention. Those modifications and variations therefore should be deemed as falling within the scope of the invention as claimed.

What is claimed is:

1. An aquarium lid, comprising a lid body made of a transparent rigid material, wherein an outer edge of the lid body is designed to have a shape adapted to an edge of a mouth of an aquarium; the lid body has a plurality of shaped bumps; a planar region is formed at a top surface of the shaped bumps, or the planar region is formed between at least two shaped bumps, or the planar regions are formed at the top surface of the shaped bumps and between the at least two shaped bumps respectively.

2. The aquarium lid according to claim 1, further comprising an accessory frame, wherein the accessory frame is arranged on an edge of an side wall of the mouth of the aquarium and is provided with a horizontally extended edge directing toward the interior of the aquarium, the outer edge of the lid body is attached onto an upper surface of the horizontally extended edge.

3. The aquarium lid according to claim 2, wherein the horizontally extended edge of the accessory frame is located under a topmost part of the side wall of the mouth of the aquarium.

4. The aquarium lid according to claim 1, wherein the lid body is made of a material comprising, a translucent or transparent glass or plastic.

5. The aquarium lid according to claim 1, wherein the shaped bump is peak-shaped.

6. The aquarium lid according to claim 1, wherein a side of the lid body is provided with an edge notch.

7. The aquarium lid according to claim 1, wherein the shaped bumps and/or the planar region between at least two shaped bumps have a through-hole.

8. An aquarium, comprising the aquarium lid of claim 1.

9. An aquarium, comprising the aquarium lid of claim 2.

10. An aquarium, comprising the aquarium lid of claim 3.

11. An aquarium, comprising the aquarium lid of claim 4.

12. An aquarium, comprising the aquarium lid of claim 5.

13. An aquarium, comprising the aquarium lid of claim 6.

14. An aquarium, comprising the aquarium lid of claim 7.

15. The aquarium according to claim 8, further comprising a lighting system being located under the aquarium.

16. The aquarium according to claim 9, further comprising a lighting system being located under the aquarium.

17. The aquarium according to claim 10, further comprising a lighting system being located under the aquarium.

18. The aquarium according to claim 11, further comprising a lighting system being located under the aquarium.

19. The aquarium according to claim 12, further comprising a lighting system being located under the aquarium.

20. The aquarium according to claim 13, further comprising a lighting system being located under the aquarium.

21. The aquarium according to claim 14, further comprising a lighting system being located under the aquarium.

22. The aquarium according to claim 15, wherein the lighting system comprises a plurality of LED lights emitting different colors.

23. The aquarium according to claim 16, wherein the lighting system comprises a plurality of LED lights emitting different colors.

24. The aquarium according to claim 17, wherein the lighting system comprises a plurality of LED lights emitting different colors.

25. The aquarium according to claim 18, wherein the lighting system comprises a plurality of LED lights emitting different colors.

26. The aquarium according to claim 19, wherein the lighting system comprises a plurality of LED lights emitting different colors.

27. The aquarium according to claim 20, wherein the lighting system comprises a plurality of LED lights emitting different colors.

28. The aquarium according to claim 21, wherein the lighting system comprises a plurality of LED lights emitting different colors.
